(19) United States
(12) Patent Application Publication
(10) Pub. No.: US 2024/0402101 A1
(43) Pub. Date: Dec. 5, 2024

(54) X-RAY ANALYZER

(71) Applicant: SHIMADZU CORPORATION, Kyoto-shi (JP)

(72) Inventor: Tetsuya YONEDA, Kyoto-shi (JP)

(21) Appl. No.: 18/291,842

(22) PCT Filed: Mar. 15, 2022
(86) PCT No.: PCT/JP2022/011513

§ 371 Date: Jan. 24, 2024

(30) Foreign Application Priority Data
Aug. 10, 2021 (JP) 2021-130571

(51) Int. Cl. G01N 23/2209; G01N 23/223

(52) U.S. Cl. CPC G01N 23/2209; G01N 23/223; G01N 2223/056; G01N 2223/076; G01N 2223/079; G01N 2223/321; G01N 2223/5015

(57) ABSTRACT

An X-ray analyzer includes an analyzing crystal configured to spectrally disperse characteristic X-rays for each wavelength, the characteristic X-rays being generated by a sample irradiated with the excitation ray, and a plurality of detection elements arranged to each detect intensity of a characteristic X-ray for each wavelength, the characteristic X-ray being spectrally dispersed by the analyzing crystal. An angle between a direction of the characteristic X-ray spectrally dispersed at a middle point of an effective surface of the analyzing crystal and an array direction of the plurality of detection elements is less than 80 degrees or 100 degrees or more.

### TECHNICAL FIELD

The present disclosure relates to an X-ray analyzer.

### BACKGROUND ART

Characteristic X-rays emitted by a sample irradiated with an excitation ray have wavelengths each determined by an element contained in the sample. Therefore, the compositions of the sample can be determined by detecting the intensity of the characteristic X-ray for each wavelength. The method of detecting characteristic X-rays by measuring the intensity for each wavelength is called a “wavelength-dispersive” method.

As one example of the wavelength-dispersive X-ray analyzer, Japanese Unexamined Patent Application Publication No. 2017-223638 (Patent Document 1) discloses an X-ray analyzer capable of measuring compositions of a sample with high sensitivity by a spectroscopy technology. In this X-ray analyzer, an excitation source irradiates a sample with an excitation ray, and the sample irradiated with the excitation ray generates characteristic X-rays. The generated characteristic X-rays pass through a slit and reach an analyzing crystal. As the characteristic X-rays pass through this slit, the incident angle of the characteristic X-ray on the analyzing crystal varies depending on the generation position of the characteristic X-ray on the sample. The characteristic X-rays spectrally dispersed by the analyzing crystal reach a detector. The detector is composed of a plurality of detection elements arranged in a predetermined direction, and each of the plurality of detection elements detects the intensity (hereinafter also referred to as “X-ray intensity”) of each of characteristic X-rays different in energy depending on the incident angle of the characteristic X-ray to the analyzing crystal crystal. The X-ray analyzer generates an X-ray spectrum based on the X-ray intensity corresponding to the energy detected by each of the plurality of detection elements. And, the X-ray analyzer analyzes the sample based on the X-ray spectrum.

### PRIOR ART DOCUMENT

### Patent Document

Patent Document 1: Japanese Unexamined Patent Application Publication No. 2017-223638

### SUMMARY OF THE INVENTION

### Problems to be Solved by the Invention

In the above-described X-ray analyzer, in order to detect a wider energy range with a given number of detection elements, it is preferable to set the angle between the direction of the characteristic X-ray spectrally dispersed at the middle point of the surface of the analyzing crystal and the array direction of the plurality of detection elements to 90 degrees. Further, it may not always be possible to set the angle to 90 degrees due to the problem of a space to arrange the detection elements in the X-ray analyzer and the fact that the pitch of the detection elements differs depending on the detection energy. Even in such a case, the angle between the direction of the characteristic X-ray spectrally dispersed at the middle point of the surface of the analyzing crystal and the array direction of the plurality of detection elements is set to 80 degrees or more and less than 100 degrees.

Further, it is desired to increase the number of measuring points in the X-ray analyzer described above to acquire a more accurate characteristic X-ray spectrum. With this, it is possible to accurately identify the peak positions in the spectrum to perform a highly accurate sample analysis. For this purpose, it is necessary to reduce the pitch of detection elements. For example, it is conceivable to use a plurality of detection elements each having a short width by downsizing the detection elements. However, the shorter the width of the detection element, the higher dimensional accuracy must be achieved at the production stage of the detection element, which makes it difficult to produce a miniaturized detection element from the standpoint of production limitations and production costs.

The present invention has been made to solve the above-described problems, and the purpose of the present invention is to improve analysis accuracy of a sample without downsizing a detection element.

### Means for Solving the Problems

The X-ray analyzer of the present disclosure is provided with an excitation source, an analyzing crystal, and a plurality of detection elements. The excitation source is configured to irradiate a sample with an excitation ray. The analyzing crystal is configured to spectrally disperse characteristic X-rays for each wavelength, the characteristic X-rays being generated by the sample irradiated with the excitation ray. The plurality of detection elements is arranged to each detect intensity for each wavelength, the characteristic X-rays being spectrally dispersed by the analyzing crystal. And, an angle between a direction of the characteristic X-rays spectrally dispersed at a middle point of an effective surface of the analyzing crystal and an array direction of the plurality of detection elements is less than 80 degrees or 100 degrees or more. Note that the effective surface of the analyzing crystal is a portion where characteristic X-rays incident on the effective area of the detector out of the characteristic X-rays dispersed by the analyzing crystal are spectrally dispersed.

### Effects of the Invention

According to the X-ray analyzer of the present disclosure, it is configured such that the angle between the direction of the characteristic X-ray spectrally dispersed at the middle point of the effective surface of the analyzing crystal and the array direction of the plurality of detection elements is less than 80 degrees or 100 degrees or more. Therefore, it is possible to pseudo-shorten the pitch of the plurality of detection elements when viewing the plurality of detection elements from the middle point of the surface of the analyzing crystal using existing detection elements. Therefore, it is possible to pseudo-shorten the detection element pitch using existing detection elements, which in turn can increase the number of measuring points per unit wavelength to improve the accuracy of the sample analysis.

### BRIEF DESCRIPTION OF THE DRAWINGS

FIG. 1 is a schematic configuration diagram showing an X-ray analyzer according to this embodiment.

FIG. 2 is a diagram schematically showing an internal configuration of a device body 10.

FIG. 3 is a diagram showing an analyzing crystal and a detector of the X-ray analyzer.

FIG. 4 is a diagram showing the detector in the analyzer and a direction P when the angle φ is 90 degrees.

FIG. 5 is a diagram showing the detector in the X-ray analyzer and the direction P according to this embodiment.

FIG. 6 is a diagram showing a part of an X-ray spectrum.

FIG. 7 is a configuration example of a device body of the analyzer according to a second embodiment.

FIG. 8 is one example of a table showing the relation between a width of a wavelength range input by a user and an angle φ.

FIG. 9 is one example of a table showing a relation between a mode input by the user and an angle φ.

### EMBODIMENTS FOR CARRYING OUT THE INVENTION

Hereinafter, some embodiments of the present disclosure will be described in detail with reference to the attached drawings. Note that the same or equivalent part in the figures is assigned by the same reference symbol, and the description will not be repeated. Further, it should be noted that in the embodiment and modifications, it is planned from the beginning at the time of filing this application to combine the configurations described in the embodiments as appropriate, including combinations not described in the specification, to the extent that no inconvenience or inconsistency arises.

### First Embodiments

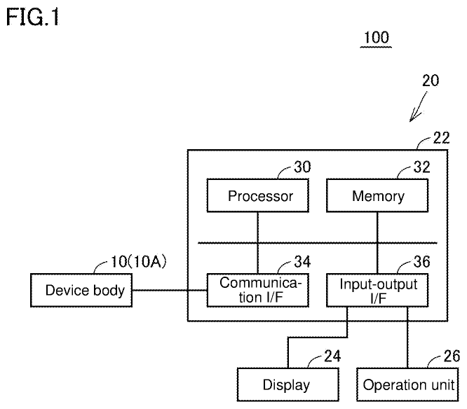

The X-ray analyzer according to this embodiment is an X-ray analyzer equipped with a wavelength-dispersive spectrometer. Hereafter, a wavelength dispersive X-ray fluorescence analyzer will be described as one example of the X-ray analyzer according to the embodiment. The “wavelength dispersive” method is a method of spectrally dispersing characteristic X-rays with an analyzing element and detecting a characteristic X-ray spectrum by measuring the characteristic X-ray intensity for each target wavelength. FIG. 1 is a schematic configuration diagram showing an X-ray analyzer (hereinafter also referred to as “analyzer 100”) according to this embodiment.

Referring to FIG. 1, the analyzer 100 is provided with a device body 10 and a signal processor 20. The device body 10 is configured to irradiate a sample with an excitation ray and detect characteristic X-rays generated from the sample. The excitation ray is typically X-rays. The detection signal corresponding to the characteristic X-ray detected by the device body 10 is transmitted to the signal processor 20. The signal processor 20 is provided with a controller 22, a display 24, and an operation unit 26. The display 24 and the operation unit 26 are connected to the controller 22. The signal processor 20 controls the operation of the device body 10. The signal processor 20 is configured to analyze the detection signal transmitted from the device body 10 and display the result based on the analysis on the display 24. The display 24 is configured by a liquid crystal panel or the like capable of displaying an image. The operation unit 26 receives a user's operation input to the analyzer 100. The operation unit 26 is typically configured by a touch panel, a keyboard, a mouse, or the like.

The controller 22 includes, as its main components, a processor 30, a memory 32, a communication interface (I/F) 34, and an input-output I/F 36. These parts are connected to each other communicatively via a bus.

The processor 30 is typically an arithmetic processing unit, such as, e.g., a CPU (Central Processing Unit) and an MPU (Micro Processing Unit). The processor 30 reads and executes the program stored in the memory 32 to control the operation of each part of the analyzer 100. Specifically, the processor 30 realizes the analysis processing of the detection signal transmitted from the device body 10 by executing the program. Note that although in the example shown in FIG. 1, a configuration is illustrated in which the processor is composed of a single processor, the controller 22 may be configured to include a plurality of processors.

The memory 32 is realized by a non-volatile memory, such as, e.g., a RAM (Random Access Memory), a ROM (Read Only Memory), and a flash memory. The memory 32 stores programs to be executed by the processor 30, data to be used by the the processor 30, or the like.

The input-output I/F 36 is an interface for exchanging various data between the processor 30, the display 24, and the operation unit 26.

The communication I/F 34 is a communication interface for exchanging various data with the device body 10 and is realized by an adapter or a connector. Note that the communication method may be a wireless communication method using a wireless LAN (Local Area Network) or a wired communication method using a USB (Universal Serial Bus) or the like.

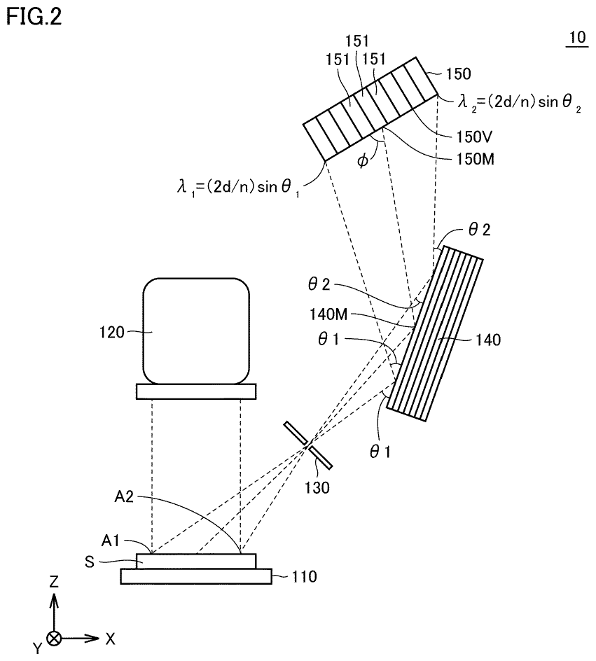

FIG. 2 is a diagram schematically showing the internal configuration of the device body 10. Referring to FIG. 2, the device body 10 is provided with a sample holder 110 for holding a sample S, an excitation source 120, a slit 130, an analyzing crystal 140, and a detector 150.

The excitation source 120 is an X-ray source that irradiates the sample S with X-rays, which are excitation light (excitation ray). An electron beam source may be used instead of the X-ray source. In FIG. 2, the plane of the sample holder 110 on which the sample S is held is defined as an X-Y plane, and the irradiation direction of the excitation ray from the excitation source 120 is defined as a Z-axis direction. The sample S may be solid, liquid, or gas, and the sample holder 110 corresponding to the state of the sample S is used.

The excitation ray emitted from the excitation source 120 is emitted onto the surface of the sample S. With this, characteristic X-rays are emitted from the sample S. In the example shown in FIG. 2, it is configured such that the surface of the sample S is irradiated with the excitation ray perpendicularly to the surface of the sample S. However, it can be configured such that the excitation ray is emitted at an angle inclined to the surface of the sample S.

The analyzing crystal 140 is made of, for example, a silicon single-crystal, a lithium fluoride single-crystal, or a germanium single-crystal. In the analyzing crystal 140, a specific crystal plane is parallel to the surface of the crystal. It is possible to use only the specific crystal plane for the detection of characteristic X-rays, which makes it possible to prevent accidental detection of characteristic X-rays Bragg-reflected on other crystal planes. The detector 150 is composed of a plurality of detection elements 151 arranged along a predetermined array direction. In FIG. 2, the number of detection elements 151 is 9 for convenience, but in reality, for example, the number may be 1,000 or more. The detection element 151 is made of, for example, silicon.

In the state in which the sample S is held by the sample holder 110, when the surface of the sample S is irradiated with the excitation ray from the excitation source 120, characteristic X-rays are emitted from the sample S. The emitted characteristic X-rays have different wavelengths which differ depending on the elements composing the sample S. The characteristic X-rays emitted when the region from the position A1 to the position A2 is irradiated with the excitation ray emitted from the excitation source 120 pass through the slit 130 and reach the analyzing crystal 140. In FIG. 2, by way of example, the characteristic X-rays generated at the positions A1 and A2 are shown by dashed lines. The position A2 is located in the positive direction of the X-axis from the position A1. The irradiation region at the position A1 and the irradiation region at the position A2 both extend in the Y-axis direction.

When the angle between the analyzing crystal 140 and the incident characteristic X-ray is 0, the incident angle of the characteristic X-ray is (90-θ) degrees. Due to the arrangement angle between the surface of the sample S fixed to the sample holder 110 and the surface of the analyzing crystal 140, the characteristic X-ray emitted at the position A1 incidents on the analyzing crystal 140 at an incident angle of (90-θ₁) degrees, and the characteristic X-ray emitted at the position A2 incidents on the analyzing crystal 140 at an incident angle of (90-θ₂) degrees. In other words, by making the characteristic X-rays pass through the slit 130, the incident angle of the characteristic X-ray to the analyzing crystal 140 can be changed according to the generation position of the characteristic X-ray on the sample S.

Among the characteristic X-rays incident from the sample S to the analyzing crystal 140 at an incident angle (90-θ) degrees, only characteristic X-rays with wavelengths satisfying the Bragg condition formula λ=(2d/n) sin θ(“λ” is the wavelength of the characteristic X-ray, “d” is the crystal face spacing of the analyzing crystal 140, “n” is the order) are spectrally diffracted by the analyzing crystal 140 and reach the detector 150. In this embodiment, although the slit 130, the analyzing crystal 140, and the detector 150 are fixed, it is configured such that the characteristic X-rays having wavelengths satisfying the equation of the Bragg condition in the range θ₂<θ<θ₁ are dispersed by the analyzing crystal 140 and reach the detector 150.

The characteristic X-rays spectrally dispersed by the analyzing crystal 140 are emitted at the same angle as the incident angle, and therefore, the Bragg-reflected characteristic X-ray is detected by the detection element 151 arranged at the position corresponding to the outgoing angle among the plurality of detection elements 151. Specifically, in the example shown in FIG. 2, the characteristic X-ray satisfying the wavelength λ₁=(2d/n) sin θ₁ among the characteristic X-rays emitted from the position A1 is illustrated. Further, the characteristic X-ray satisfying the wavelength λ₂=(2d/n) sin θ₂ among the characteristic X-rays emitted from the position A2 is illustrated.

In this manner, the characteristic X-ray having a wavelength satisfying the Bragg condition of different diffraction angles is detected for each detection element. In other words, the analyzer 100 can recognize the wavelength contained in the characteristic X-ray by knowing the detection element that detected the characteristic X-ray. On the other hand, the wavelength of the characteristic X-ray differs for each element. Thus, the analyzer 100 can analyze the sample (e.g., identify the element contained in the sample) by identifying the detection element that detected the characteristic X-ray in the detector 150.

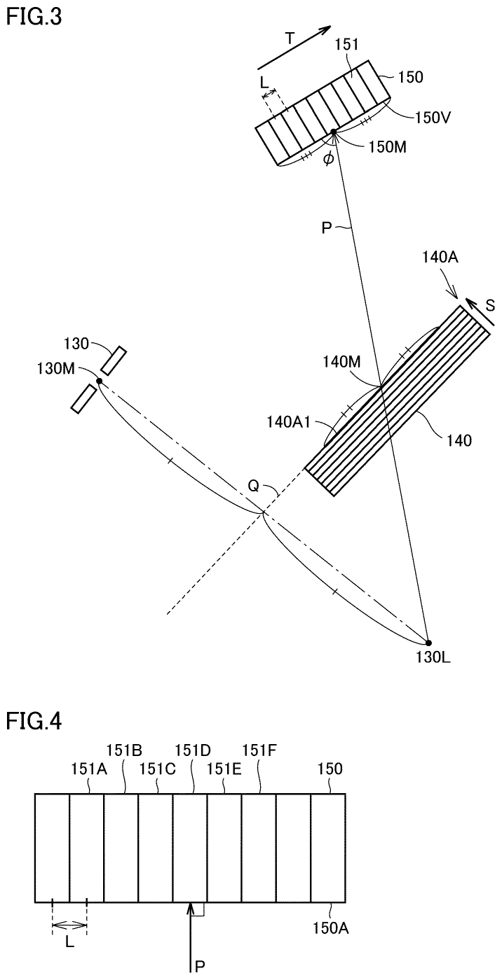

As described above, the device body 10 spectrally disperses the characteristic X-rays generated by the sample irradiated with the excitation ray to detect the intensity for each wavelength. The device body 10 transmits the intensity for each detection element to the signal processor 20. The signal processor 20 can acquire an X-ray spectrum in which the energy corresponding to the wavelength of the characteristic X-ray detected by each detection element and the intensity of the characteristic X-ray corresponding to the energy are associated. Note that in the energy E and the wavelength λ, the equation E=hc/λ holds (“h” is a Planck's constant and “c” is a light speed). The analysis of the sample (e.g., identification of contained elements in the sample) can be performed by comparing the X-ray spectrum of a known sample with the acquired X-ray spectrum with the signal processor 20. Note that the middle point 140M, the middle point 150M, the detection surface 150V, and the angle φ in FIG. 2 will be explained with reference to FIG. 3.

FIG. 3 is a diagram showing the slit 130, the analyzing crystal 140, and the detector 150 of the analyzer 100 of this embodiment. In FIG. 3, for convenience, the orientation, etc., of the slit 130, the analyzing crystal 140, and the detector 150 are changed from those shown in FIG. 2.

As shown in FIG. 3, hereinafter, the surface of the analyzing crystal 140 will be referred to as a “surface 140A” (see also FIG. 2). The surface 140A is perpendicular to the array direction S of the crystal planes of the analyzing crystal 140. The portion of the surface 140A in the range where the characteristic X-rays are incident on the effective region of the detector is referred to as an “effective surface 140A1.” The point of symmetry with the center portion 130M of the opening of the slit 130 with respect to the extension line Q of the surface 140A is referred to as a “symmetry point 130L.” Further, the middle point (the center point) of the effective surface 140A1 of the analyzing crystal 140 is referred to as a “middle point 140M.” The detection surface where the characteristic X-rays spectrally dispersed by the analyzing crystal 140 are detected, i.e., the detection effective region of the detector 150, is referred to as a “detection surface 150V.” The middle point (the point in the center portion of the detection surface 150V) of the detection surface 150V in the array direction T of the plurality of detection elements 151 is referred to as “middle point 150M.” Each of the middle point 140M and the middle point 150M is the middle point of the effective surface 140A1 and the middle point of the detection surface 150V when viewed from the extension direction of the surface 140A (the Y-axis direction shown in FIG. 2). Further, the distance between the center lines of the adjacent detection elements 151 is referred to as “width L.” The width Lis also referred to as a “detection element pitch.”

The direction from the middle point 140M to the middle point 150M is referred to as a “direction P.” In this embodiment, it is configured such that the symmetry point 130L, the middle point 140M, and the middle point 150M are arranged on the straight line along the direction P. The detector 150 is arranged such that the angle φ between the array direction T and the direction P is within the range of less than 80 degrees or 100 degrees or more. In this embodiment, the angle φ and the detector 150 are fixed. The angle φ is also defined as an angle between the traveling direction (i.e., the direction P) of the characteristic X-ray spectrally dispersed at the middle point 140M and the array direction T. The reasons for setting the angle φ to less than 80 degrees or 100 degrees or more will be described below. Further, as shown in FIG. 2, the angle φ between the direction (direction P) of the characteristic X-ray spectrally dispersed at the middle point 140M of the effective surface 140A1 of the analyzing crystal and the array direction T of the plurality of detection elements is the angle φ. Further, in the example shown in FIG. 2, the position at which the characteristic X-ray spectrally dispersed at the middle point 140M reaches the plurality of detection elements 151 is the middle point 150M.

To improve the analysis accuracy of the sample by the analyzer 100, it is desired to increase the number of measuring points in the characteristic X-ray spectrum, i.e., to improve the accuracy of peak fitting of the X-ray intensity.

To increase the number of measuring points in the characteristic X-ray spectrum, it is conceivable to shorten the distance L between the center lines of the adjacent detection elements 151. However, in the process of producing detection elements, when the detection element pitch L is reduced, higher dimensional accuracy is required. To achieve higher dimensional accuracy, the production cost generally increases. Furthermore, depending on the required dimensional accuracy, the detection element itself may not be produced due to problems such as, e.g., limitations in the processing accuracy of parts.

In view of these problems, the analyzer 100 in this embodiment adopts the configuration in which the detector 150 is arranged with respect to the analyzing crystal 140 such that the angle φ described in FIG. 3 becomes less than 80 degrees or 100 degrees or more. It may be configured such that the detector 150 is arranged with respect to the analyzing crystal 140 such that all of the straight lines connecting the surface 140A of the analyzing crystal 140 and the detection surface 150V are less than 80 degrees or 100 degrees or more.

With this, it is possible to pseudo-shorten the detection element pitch L with respect to the radiation direction of the diffracted characteristic X-ray. Therefore, in the X-ray analyzer of this embodiment, although the energy range to be measured is reduced, the number of measuring points per unit wavelength (or per unit energy) in the characteristic X-ray spectrum can be increased while using the existing size of the detection element. Note that the unit wavelength indicates a wavelength of a given length. Also note that the unit energy indicates the energy of a given magnitude.

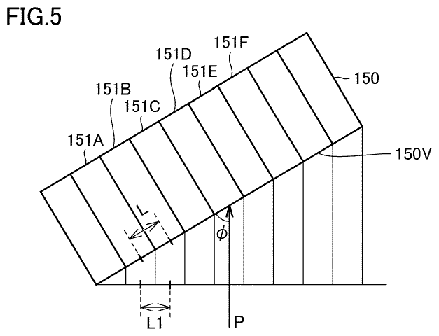

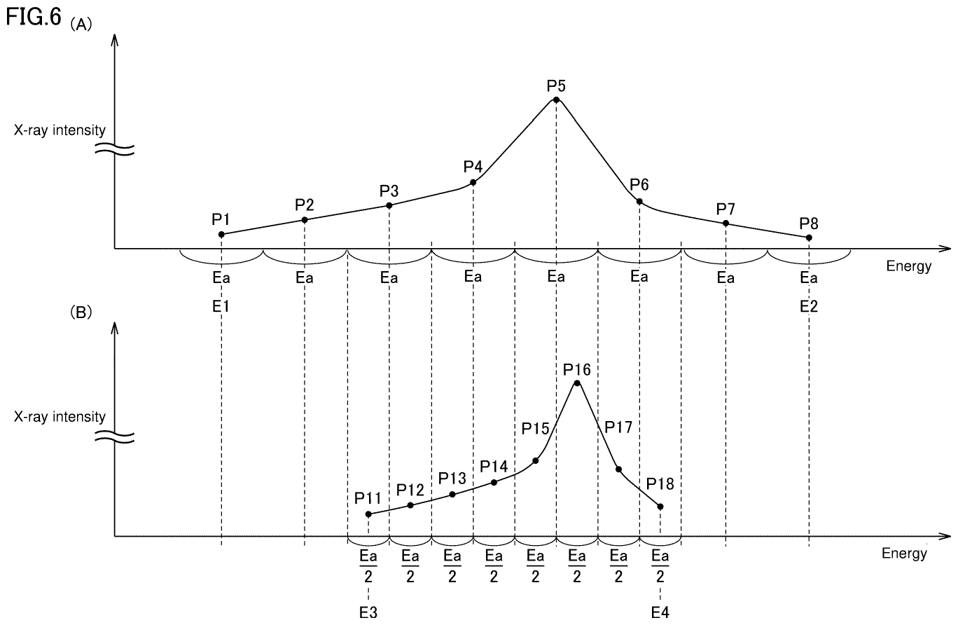

Next, with reference to FIG. 4 and FIG. 5, the reason that the number of measuring points increases will be detailed. FIG. 4 is a diagram showing the detector 150 and the direction P in the analyzer (hereinafter also referred to as “X-ray analyzer of Comparative Example”) when the angle φ is π/2. As shown in FIG. 4, the pitch of the detection elements 151 when viewed from the direction P (from the middle point 140M to the middle point 150M) is the width L. FIG. 5 is a diagram showing the detection elements 151 and the direction P in the X-ray analyzer of this embodiment. As shown in FIG. 5 (also see FIG. 2), the angle φ between the direction P and the detection surface 150V of a plurality of detection elements 151 is an angle different from π/2 and is less than 80 degrees and 100 degrees or more. Therefore, the width of the detection element 151 when viewed from the direction P is L1 (=L sin φ). Therefore, the pitch of the detection elements 151 can be pseudo-shortened. As a result, although the energy range to be detected decreases when viewed across the entire detector 150, the predetermined energy range (energy range E3-E4 in FIG. 6(B) shown below) is detected by a larger number of detection elements 151, thereby increasing the number of measuring points in the spectrum. As a result, the analyzer 100 can perform an analysis with higher precision.

For example, if φ=π/6, then L1=L sin (π/6)=L/2. If ϕ=π/4, then L1=L sin (π/4)=L/(√2). If ϕ=π/3, then L1=L sin (π/3=L/(√3)/2

As described above, the angle φ is an angle belonging to the range of less than 80 degrees or 100 degrees or more. In particular, it may be configured such that the angle φ is an angle belonging to the range of less than 70 degrees or 120 degrees or more. By adopting such a configuration, the number of measuring points can be further increased. Furthermore, it may be configured such that the angle φ is 30 degrees. This configuration allows the number of measuring points to be doubled in the above-described predetermined energy range, as compared with the case where the angle φ is 90 degrees.

FIG. 6 is a diagram showing a part of an X-ray spectrum. In the example shown in FIG. 6, the vertical axis represents the intensity of a characteristic X-ray, and the horizontal axis represents the energy of the characteristic X-ray. FIG. 6(A) is a diagram showing a part of the X-ray spectrum of the analyzer (analyzer with an angle φ=90 degrees) of Comparative Example. FIG. 6(B) is a diagram showing a part of the X-ray spectrum of the analyzer 100 of this embodiment when the angle φ=π/6.

In the example shown in FIG. 6(A), the detection element pitch viewed from the direction P is a width L, and the interval of the detection energy corresponding to the width L is Ea. Further, in FIG. 6(A), the X-ray intensities P1-P8 in the energy range E1-E2 are shown. Further, in FIG. 6(B), the X-ray intensities P11-P18 in the energy range E3-E4 are shown. Note that the energy range E3-E4 is smaller than the energy range E1-E2.

In the X-ray spectrum shown in FIG. 6(B), the pitch of the detection elements 151 as viewed from the direction P is a pseudo-width L/2. Therefore, as compared with the case shown in FIG. 6(A), the energy detection range is half, but the analyzer 100 can produce a characteristic X-ray spectrum with twice the number of measuring points. For example, in FIG. 6(A), in this energy range, the number of measuring points is four points, i.e., the X-ray intensity P3 to the X-ray intensity P6, but in FIG. 6(A), the number of measuring points is eight points, i.e., the X-ray intensity P11 to the X-ray intensity P18.

For example, the range detected by a single detection element in FIG. 6(A) is detected by two adjacent detection elements in FIG. 6(B). That is, for example, the X-ray intensity P5 shown in FIG. 6(A) is a sum of the X-ray intensity P15 and the X-ray intensity P16 shown in FIG. 6(B).

Further, in the range shown in FIG. 6, the peak is actually located at the energy of P16, as shown in FIG. 6(B). However, in the case of FIG. 6(A), it will be shown as P5 which is a position displaced from P16. As described above, the analyzer 100 of this embodiment can produce a characteristic X-ray spectrum with a larger number of measuring points by reducing the pitch of the detection elements 151 as viewed from the direction P (planar view). That is, the analyzer 100 of this embodiment can perform an analysis with a higher degree of accuracy. This makes it possible to accurately identify the peak position.

As described above, in the analyzer 100 of this embodiment, the number of measuring points can be increased by setting the angle φ to less than 80 degrees or 100 degrees or more. Therefore, the analyzer 100 of this embodiment can perform a higher-precision analysis using existing detection elements.

Note that when φ=less than 80 degrees or 100 degrees or more, the amount of characteristic X-rays incident on one detection element decreases, so the intensity of the characteristic X-ray detected by each detection element becomes lower than in the case of φ=π/2. More specifically, the intensity of the characteristic X-ray detected by one detection element when φ=less than 80 degrees or 100 degrees or more is sin φ times the intensity of the characteristic X-ray detected by one detection element when the angle φ=π/2. In other words, the smaller the angle φ is, the lower the X-ray intensity detected by a single detection element, so if the angle φ is made too small, it may conversely become difficult to detect peaks. Furthermore, the overall detection range of the detector 150 becomes narrower, so it is necessary to increase the number of detection elements in order to perform the detection in the same range. In other words, the angle φ is preferably determined by considering the desired number of measuring points, the X-ray intensity detected by a single detection element, and the cost.

### Second Embodiments

In the first embodiment, an example is described in which the detector 150 and the angle φ are fixed. In the analyzer 100 of the second embodiment, a configuration in which the angle φ can be changed is described.

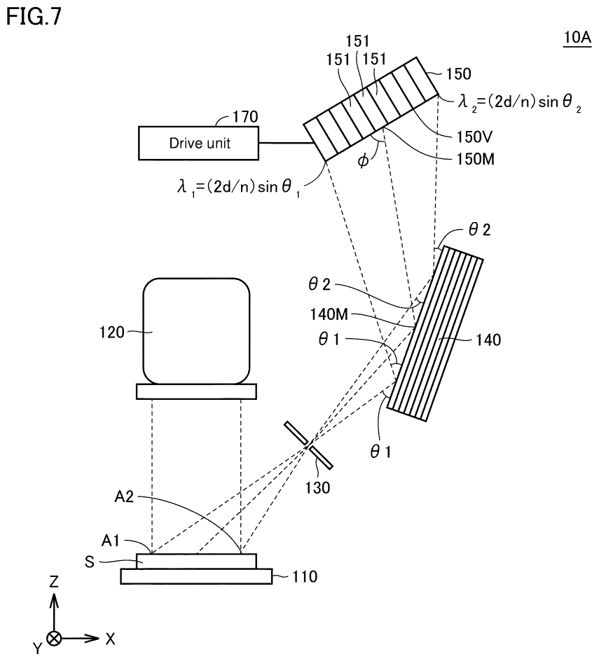

FIG. 7 is a configuration example of a device body 10A of an analyzer according to a second embodiment. As shown in FIG. 7, the device body 10A is equipped with a drive unit 170 for driving the detector 150 (a plurality of detection elements 151). The drive unit 170 is controlled by the signal processor 20.

In some cases, the user knows the wavelength range of characteristic X-rays generated by the sample S because the user knows the elements of the sample S. In view of such a case, the signal processor 20 of this embodiment can accept an input from the user for the wavelength range (or energy range) used by the signal processor 20. The signal processor 20 displays the X-ray spectrum in the energy range corresponding to the input wavelength range, while it does not display the X-ray spectrum in the energy range corresponding to wavelength ranges other than the input wavelength range. Therefore, the analyzer 100 displays only the X-ray spectrum in the wavelength range desired by the user, thus avoiding the display of X-ray spectra unnecessary for the user.

Further, as shown in FIG. 6, when the angle φ is 80 degrees or more and less than 100 degrees, the wavelength range (or energy range) to be detected becomes wider, while when the angle φ is less than 80 degrees and 100 degrees or more, the number of measuring points increases. Note that in this embodiment, it is assumed that the angle φ is an angle of 90 degrees or less.

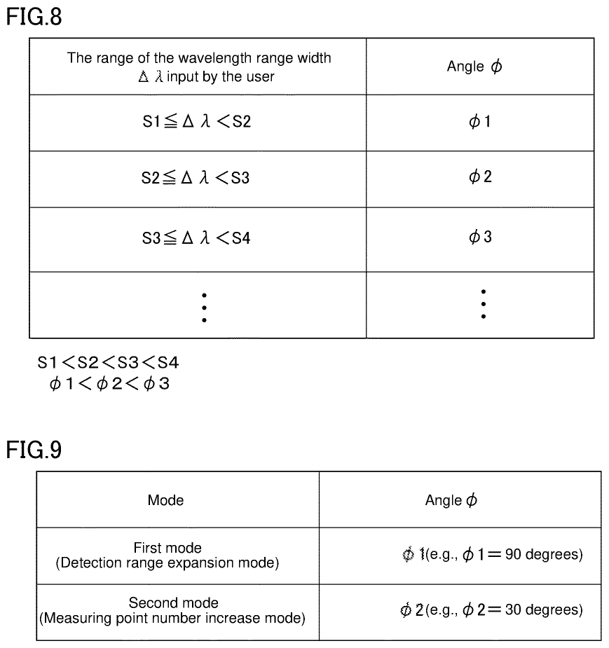

Therefore, the larger the wavelength range width Δλ input by the user, the drive unit 170 drives the detector 150 to increase the angle φ. Note that the wavelength range width Δλ is a differential value between the wavelength of the maximum value and the wavelength of the minimum value in the wavelength range. FIG. 8 is an example of a table showing the relation between the wavelength range width Δλ for the wavelength range input by the user and the angle φ. This table is stored, for example, in the memory 32. Note that in FIG. 8, S1<S2<S3<S4, and φ1<φ2<<φ3.

In the example of FIG. 8, when the wavelength range width Δλ of the input wavelength range is S1≤Wavelength range width Δλ><S2, the signal processor 20 controls the drive unit 170 so that the angle φ becomes the angle φ1. When the wavelength range width Δλ of the input wavelength range is S2<Wavelength range width Δλ<S3, the signal processor 20 controls the drive unit 170 so that the angle φ becomes the angle φ2. When the wavelength range width Δλ of the input wavelength range is S3≤Wavelength range width Δλ<S4, the signal processor 20 controls the drive unit 170 so that the angle φ becomes the angle φ3.

In this embodiment, the signal processor 20 controls the drive unit 170 so that it becomes the value (angle) corresponding to the width of the wavelength range input by the user. More specifically, the larger the wavelength range width Δλ, the larger the angle φ. In other words, when the input wavelength range width Δλ is large, the signal processor 20 can increase the wavelength range (energy range) by increasing the angle φ(angle φ is 90 degrees or close to 90 degrees) (see FIG. 6(A)). On the other hand, when the input wavelength range width Δλ is small, the signal processor 20 reduces the angle φ to improve the analysis accuracy by increasing the number of measuring points in this wavelength range. Therefore, in the analyzer of this embodiment, the analysis corresponding to the wavelength range desired by the user can be performed.

### Third Embodiment

As described above, when the angle φ is between 80 degrees or more and less than 100 degrees, the wavelength range (or energy range) to be detected becomes wider, while when the angle φ is less than 80 degrees and 100 degrees or more, the number of measuring points per unit wavelength (or per unit energy) increases (see FIG. 6). In view of this, in the third embodiment, the user can select one of several modes, including a first mode and a second mode, by operating the operation unit 26. The signal processor 20 sets the selected mode. For example, the signal processor 20 stores a mode flag indicating the mode selected by the user in the memory 32. For example, the signal processor 20 stores a first mode flag in the memory 32 when the first mode is selected. Further, when the second mode is selected, the signal processor 20 stores a second mode flag in the memory 32.

FIG. 9 is a diagram showing the first mode and the second mode. As shown in FIG. 9, the first mode is a mode that extends the energy detection range more than the second mode. In the first mode, the angle φ is an angle φ1. The angle φ1 can be any of the angles in the range of 80 degrees or more and the range of less than 100 degrees. The angle φ1 is, for example, 90 degrees. Further, the second mode is a mode in which the number of measuring points can be increased than in the first mode. In the second mode, the angle φ is an angle φ2. The angle φ2 can be any of the angles in the range of less than 80 degrees and in the range of 100 degrees or more. The angle φ2 is, for example, 30 degrees.

According to the third embodiment, the user can select the first mode in which the detection range is extended or the second mode in which the number of measuring points is increased. Thus, the user convenience can be improved.

Note that in the second embodiment and the third embodiment, a configuration is described in which the signal processor 20 controls the drive unit 170 so that it automatically changes the angle φ. However, it may be configured such that the user operates the operation unit 26 to control the drive unit 170. With this configuration, the angle φ can be set to the angle desired by the user.

### Aspects

It would be understood by those skilled in the art that the plurality of exemplary embodiments described above is specific examples of the following aspects.

### (Item 1)

An X-ray analyzer according to one aspect includes:
an excitation source configured to irradiate a sample with an excitation ray;
an analyzing crystal configured to spectrally disperse characteristic X-rays for each wavelength, the characteristic X-rays being generated by the sample irradiated with the excitation ray; and
a plurality of detection elements arranged to each detect intensity of a characteristic X-ray for each wavelength, the characteristic X-ray being spectrally dispersed by the analyzing crystal,
wherein an angle between a direction of the characteristic X-ray spectrally dispersed at a middle point of an effective surface of the analyzing crystal and an array direction of the plurality of detection elements is less than 80 degrees or 100 degrees or more.

According to the X-ray analyzer as recited in the above-described Item 1, the number of measuring points in the characteristic X-ray spectrum can be increased, and therefore, the energy resolution of characteristic X-rays can be improved.

### (Item 2)

In the X-ray analyzer as recited in the above-described Item 1, the angle is less than 70 degrees or 120 degrees or more.

According to the X-ray analyzer as recited in the above-described Item 2, the number of measuring points in the characteristic X-ray spectrum can be increased, and therefore, the energy resolution of the characteristic X-ray can be improved.

### (Item 3)

In the X-ray analyzer as recited in the above-described Item 1, the above-described angle is 30 degrees.

According to the X-ray analyzer as recited in the above-described Item 2, the number of measuring points can be doubled, as compared with the characteristic X-ray spectrum in which the above-described angle is 90 degrees.

### (Item 4)

The X-ray analyzer as recited in any one of the above-described Items 1 to 3 further includes a drive unit configured to move the plurality of detection elements to change the angle.

According to the X-ray analyzer as recited in the above-described Item 4, it is possible to prevent the same characteristic X-ray from being detected in a plurality of detection elements.

### (Item 5)

The X-ray analyzer as recited in the above-described Item 4, further comprising:
a signal processor configured to analyze the sample based on the intensity of the characteristic X-ray for each wavelength and control the drive unit, the intensity being detected by the plurality of detection elements, and
wherein the signal processor is configured to
accept an input for a wavelength range for analyzing the sample from a user,
analyze the sample based on the intensity for each wavelength included within the input wavelength range out of the intensities for each wavelength detected by the plurality of detection elements, and
control the drive unit such that the angle becomes a value corresponding to a width in the wavelength range input by the user to move the plurality of detection elements.

According to the X-ray analyzer as recited in the above-described Item 5, it is possible to control the angle to an angle corresponding to the wavelength range input by the user.

### (Item 6)

An X-ray analyzer comprising:
an excitation source configured to irradiate a sample with an excitation ray;
an analyzing crystal configured to spectrally disperse characteristic X-rays for each wavelength, the characteristic X-rays being generated by the sample irradiated with the excitation ray;
a plurality of detection elements arranged to each detect intensity of a characteristic X-ray for each wavelength, the characteristic X-ray being spectrally dispersed by the analyzing crystal;
a drive unit configured to move the plurality of detection elements to change the angle between a direction of a characteristic X-ray spectrally dispersed at a middle point of an effective surface of the analyzing crystal and an array direction of the plurality of detection elements; and
a controller configured to set a first mode and a second mode,
wherein the drive unit is configured to
move the plurality of detection elements such that the angle belongs to a range of 80 degrees or more and less than 100 degrees in a case where the first mode is set, and
move the plurality of detection elements such that the angle belongs to a range of less than 80 degrees and 100 degrees or more in a case where the second mode is set.

According to the X-ray analyzer as recited in the above-described Item 6, it is possible to control the angle to an angle corresponding to the wavelength range input by the user.

Note that the embodiments disclosed here should be considered illustrative and not restrictive in all respects. It should be noted that the scope of the present invention is indicated by claims and is intended to include all modifications within the meaning and scope of the claims and equivalents.

### DESCRIPTION OF REFERENCE SYMBOLS

10, 10A: Device body
20: Signal processor
22: Controller
24: Display
26: Operation unit
30: Processor
32: Memory
100: Analyzer
110: Sample holder
120: Excitation source
130: Slit
130L: Symmetry point
130M: Center portion
140: Analyzing crystal
140A: Surface
150: Detector
151: Element

1. An X-ray analyzer comprising:
an excitation source configured to irradiate a sample with an excitation ray;
an analyzing crystal configured to spectrally disperse characteristic X-rays for each wavelength, the characteristic X-rays being generated by the sample irradiated with the excitation ray; and
a plurality of detection elements arranged to each detect intensity of a characteristic X-ray for each wavelength, the characteristic X-ray being spectrally dispersed by the analyzing crystal,
wherein the characteristic X-ray spectrally dispersed at a middle point of an effective surface of the analyzing crystal reaches a middle point of a detection surface of the plurality of detection elements, and
wherein an angle between a direction of the characteristic X-ray spectrally dispersed at the middle point of an effective surface of the analyzing crystal and an array direction of the plurality of detection elements is less than 80 degrees or 100 degrees or more.

2. The X-ray analyzer as recited in claim 1,
wherein the angle is less than 70 degrees or 120 degrees or more.

3. The X-ray analyzer as recited in claim 2,
wherein the angle is 30 degrees.

4. The X-ray analyzer as recited in claim 1, further comprising:
a drive unit configured to move the plurality of detection elements to change the angle.

5. The X-ray analyzer as recited in claim 4, further comprising:
a signal processor configured to analyze the sample based on the intensity of the characteristic X-ray for each wavelength and control the drive unit, the intensity being detected by the plurality of detection elements, and
wherein the signal processor is configured to
accept an input for a wavelength range for analyzing the sample from a user,
analyze the sample based on the intensity for each wavelength included within the input wavelength range out of the intensities for each wavelength detected by the plurality of detection elements, and
control the drive unit such that the angle becomes a value corresponding to a width in the wavelength range input by the user to move the plurality of detection elements.

6. An X-ray analyzer comprising:
an excitation source configured to irradiate a sample with an excitation ray;
an analyzing crystal configured to spectrally disperse characteristic X-rays for each wavelength, the characteristic X-rays being generated by the sample irradiated with the excitation ray;
a plurality of detection elements arranged to each detect intensity of a characteristic X-ray for each wavelength, the characteristic X-ray being spectrally dispersed by the analyzing crystal, wherein the characteristic X-ray spectrally dispersed at a middle point of an effective surface of the analyzing crystal reaches a middle point of a detection surface of the plurality of detection elements;
a drive unit configured to move the plurality of detection elements to change the angle between a direction of a characteristic X-ray spectrally dispersed at the middle point of an effective surface of the analyzing crystal and an array direction of the plurality of detection elements; and
a controller configured to set a first mode and a second mode,
wherein the drive unit is configured to
move the plurality of detection elements such that the angle belongs to a range of 80 degrees or more and less than 100 degrees in a case where the first mode is set, and
move the plurality of detection elements such that the angle belongs to a range of less than 80 degrees and 100 degrees or more in a case where the second mode is set.
